(19) United States
(12) Patent Application Publication
(10) Pub. No.: US 2015/0148005 A1
(43) Pub. Date: May 28, 2015

(54) ELECTRONIC DEVICE LOCK SCREEN CONTENT DISTRIBUTION BASED ON ENVIRONMENTAL CONTEXT SYSTEM AND METHOD

(71) Applicant: The Rubicon Project, Inc., Playa Vista, CA (US)

(72) Inventors: Duc CHAU, Los Angeles, CA (US); Jonathan TANSAVATDI, South Pasadena, CA (US); David Han YOON, Los Angeles, CA (US)

(21) Appl. No.: 14/553,415

(22) Filed: Nov. 25, 2014

Related U.S. Application Data
(60) Provisional application No. 61/908,595, filed on Nov. 25, 2013.

(51) Int. Cl. H04M 1/725

(52) U.S. Cl. CPC H04M 1/72569; H04M 1/72572; H04M 1/72577
USPC 455/410; 455/418; 455/26.1

(57) ABSTRACT

A system and method that (i) provide for features that provide assurances to content providers that their content is being viewed in a meaningful manner and (ii) encourage user adoption of dynamic lock screen content. A system and method may include selecting content to display on a mobile electronic device may include tracking, by the mobile electronic device, applications that are actively being utilized by a user of the mobile electronic device. The mobile electronic device may determine an environmental context of the user based at least in part on the applications of which the user has been utilizing. Content to display may be selected based at least in part on the determined environmental context of the user. The selected content may be displayed by the mobile device. The environmental context may be determined based on recently used apps, geographic location, information from apps (e.g., weather), and so on.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This Application claims priority to co-pending U.S. Provisional Patent Application Ser. No. 61/908,595 filed Nov. 25, 2013; the contents of which are herein incorporated by reference in their entirety.

### BACKGROUND OF THE INVENTION

Content providers seeking reach an audience have long understood the need to adapt to audience mass behavior and location. In the early days of mass content distribution, periodicals (e.g., newspapers) and radio were the gathering points of mass audiences. Television thereafter became the mass audience medium of choice. Although television to this day still provides for mass audiences, fragmentation in television due to the large number of television networks and channels along with digital video recorders (DVRs) have caused mass audiences of television, with some notable exceptions, to erode. In recent years, the Internet has further expedited the erosion of mass audiences of television. As mobile devices have become commonplace in society, that distraction, especially with regard to smart phones and tablets, has caused the mass audiences of television to continue to erode. And, at least for the moment, mobile communications have become an increasingly popular way for people to access media in part due to the low cost and easy access.

One problem with content distribution to mobile devices is that the behavior of users is unplannable and unpredictable for content providers and content distribution networks. In other words, the use of mobile devices may vary in many different ways, including accessing the Internet via a mobile browser, accessing mobile apps, many of which are purchased to avoid undesired content while others do not support undesired content, playing games, listening to music, watching videos or movies, texting, social networking, and so on. As a result, there are limited mass audience opportunities, especially those that are predictable and plannable for content providers or their agencies. Being predictable means that a prediction or estimate can be made as to how many views or impressions of content will occur over a time period and within a geographic region. Being plannable means that content provider or its agency can plan a content distribution campaign around the predictable audience. So, for example, if a content provider determines that 40 million impressions are needed to achieve a certain sales volume, for example, then the content provider or its agency will look for the most efficient means by which such a number of impressions can be achieved using any and all content distribution platforms, such as periodicals, radio, television, Internet, and mobile device mediums.

As understood in the art, while television audiences can be large, audience targeting can be inefficient as audience demographics are only able to be estimated and user behavior (e.g., channel changing during commercials, fast forwarding to skip commercials, attention of audience during commercials, etc.) cannot be tracked. While online audiences in some cases can be identified (e.g., users logging into website) so that demographic information can be determined, most of the time a user can only be determined by his or her online behavior (e.g., monitor sites a device of an unknown user visits). One problem for online content distribution has been added formats and placements that are acceptable to users. The same and other content distribution issues also exist on mobile devices.

With regard to mobile content delivery (e.g., content distribution on mobile device platforms), content originators have historically used traditional online content distribution techniques and geo-positioning content distribution models to distribute content to mobile users, where traditional online content distribution includes displaying content on webpages, games, responsive to search requests, or other apps of which a user may access. Nielsen has determined that mobile device users spend 19% of their time texting, 17% of the time social networking, 14% of their time playing games, and less time with other functions. Nielsen has also determined that the highest amount of time spent by users on mobile devices includes looking at their lock screen, which is generally used to prevent a mobile device to be accidentally acted upon without the intention of the user. For example, the use of a lock screen prevents errant telephone calls when a mobile device is being carried in a pocket or otherwise. To unlock a lock screen, a user typically performs a gesture on a touchscreen of the mobile device, such as sliding his or her finger across the touchscreen from left to right or entering a passcode. While the lock screen has been used to display content in the past, such historical lock screen content have had both limited content provider and user acceptances for a number of reasons, including content provider distrust of actual views or effectiveness of views, users not wanting their mobile devices to be constantly displaying content every time the users touch their mobile devices when in sleep or other mode, and so on.

### SUMMARY OF THE INVENTION

To improve lock screen content distribution acceptance by content providers and adoption by users of mobile devices, one embodiment may include a system and method that (i) provide for features that provide assurances to content providers that their content is being viewed in a meaningful manner and (ii) encourage user adoption of lock screen content distribution. In one embodiment, time duration of a lock screen content being displayed may be determined and compared with a time duration threshold value to determine if the display time of the lock screen content crosses the time duration threshold. Statistical data may be generated for (i) instances where the lock screen content has been displayed for less time than the time duration threshold value and (ii) instances where the lock screen content has been displayed for more time than the time duration threshold value. In one embodiment, a lock screen content displayed for less time than the time duration threshold value may not be assessed or may be discounted to the content provider, thereby allowing the content provider to have some certainty that the user actually had time to “register” the content provider's message. In one embodiment, the lock screen content may request a certain gesture that is indicative of the user actually viewing the content even if he or she does not request additional content information. A number of examples of gestures may include: shaking the mobile device like a salt or pepper shaker (e.g., content associated with a salt product), touching one or more spots indicated on content being displayed (e.g., paintball gaming center content), moving the mobile device like throwing dice (e.g., casino ad), swirling a finger on the display or moving the device in a circular motion (e.g., soup ad), singing a song into a microphone of a mobile device (e.g., content for reality television show singing contest), and so on. Such responsiveness to lock screen content may give higher confidence to the content provider that the user has “registered” a content distribution “message.”

One embodiment of a process may include selecting content to display on a mobile electronic device may include tracking, by the mobile electronic device, applications that are actively being utilized by a user of the mobile electronic device. The mobile electronic device may determine an environmental context of the user based on the applications of which the user has been utilizing. Content to display may be selected based on the determined environmental context of the user. The selected content may be displayed by the mobile device.

### BRIEF DESCRIPTION OF THE DRAWINGS

Illustrative embodiments of the present invention are described in detail below with reference to the attached drawing figures, which are incorporated by reference herein and wherein:

FIG. 1 is screen shot of an illustrative conventional lock screen provided on mobile devices to prevent errant operations of the mobile device by a user;

FIG. 2A is a screen shot of an illustrative lock screen having lock screen content displayed with an incentive reward (i.e., $0.03) thereon;

FIG. 2B is a screen shot of the lock screen content being slid to the left to cause more information (FIG. 2C) associated with the lock screen content to be displayed;

FIG. 2C is a screen shot of illustrative information or content associated with the lock screen content of FIGS. 2A and 2B;

FIG. 2D is a screen shot of an illustrative interactive lock screen content that displays a first incentive for interacting with the content and a second incentive for selecting to view additional information associated with the content;

FIG. 2E, a screenshot of an illustrative lock screen content.

FIG. 3 is a screen shot of an illustrative account management screen that enables a user to manage rewards earned by a user;

FIG. 4 is a screen shot of an illustrative cashing out message that is displayed in response to a user electing to cash out all or a portion of rewards generated by the user in response to interacting or selecting lock screen content;

FIG. 5 is a screen shot of an illustrative donation page that allows a user to donate rewards generated by the user in response to interacting or selecting lock screen content;

FIG. 6A is a screen shot of an illustrative page that enables a user to refer the mobile app to friends;

FIG. 6B is a screen shot of an illustrative page that enables a user to invite Facebook friends to have the mobile app that enables for a mobile device to provide for lock screen content distribution and rewards the user for each friend who downloads the mobile app;

FIG. 7 is a screen shot of an illustrative page that enables a user to manage a lock screen content distribution account;

FIG. 8 is a screen shot of an illustrative page that enables for a user to manage notifications along with entering contact and demographic information for use in delivering relevant lock screen content to the user;

FIG. 9 is a screen shot of an illustrative page that enables a user to select content preferences for content to be delivered to his or her lock screen;

FIG. 10 is an illustration of an illustrative network environment in which a content space auction server may operate to enable content providers to bid for lock screen content placement on mobile devices of users;

FIG. 11 is a block diagram of an illustrative content space auction server that enables for content providers and/or their agencies to submit bids to place content on lock screens of mobile device users;

FIG. 12 is a flow diagram of an illustrative process for a server to auction lock screen content distribution space;

FIG. 13 is a flow diagram of an illustrative process for a mobile device to conduct an auction of lock screen content communicated thereto by a network server;

FIG. 14 is a block diagram of an illustrative electronic device;

FIG. 15 is a block diagram of an illustrative set of software modules configured to cause a server to provide for lock screen content distribution in accordance with one embodiment;

FIG. 16 is a flow diagram of an illustrative process for monitoring duration of display of content;

FIG. 17 is a flow diagram of an illustrative gesture detection process while displaying content;

FIG. 18 is a flow diagram of an illustrative process for selecting content based on environmental context;

FIG. 19 is a block diagram of illustrative software modules that may be executed on an electronic device; and

FIG. 20 is a block diagram of an illustrative set of software modules configured to cause a mobile device to provide for lock screen content distribution in accordance with one embodiment.

### DETAILED DESCRIPTION OF THE PREFERRED EMBODIMENT

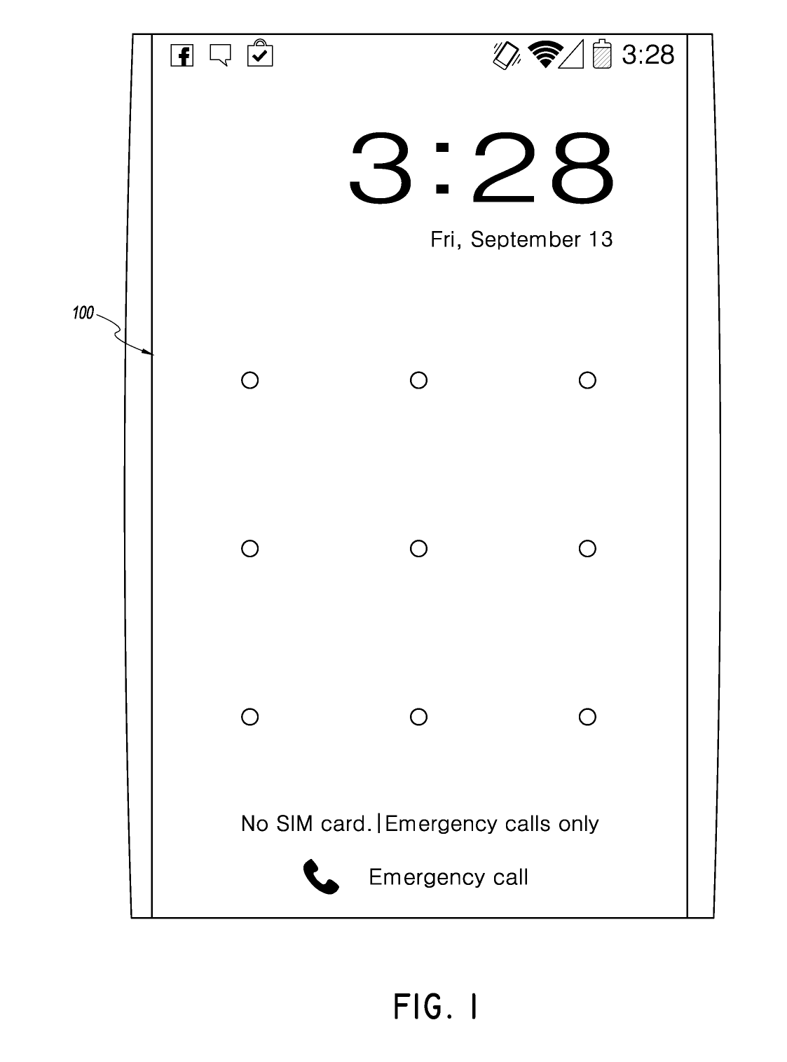

With regard to FIG. 1, a screenshot of an illustrative conventional lock screen 100 operable on a mobile electronic device, such as a smart telephone, tablet, or other electronic device (e.g., desktop computer, gaming device, etc.), is shown. As understood in the art, the lock screen 100 operates to prevent a user from activating the mobile electronic device to perform unwanted functionality when the user is carrying the mobile electronic device in his or her pocket or otherwise. The lock screen 100 as presented is conventional, and may have alternative designs for different mobile electronic devices, as understood in the art.

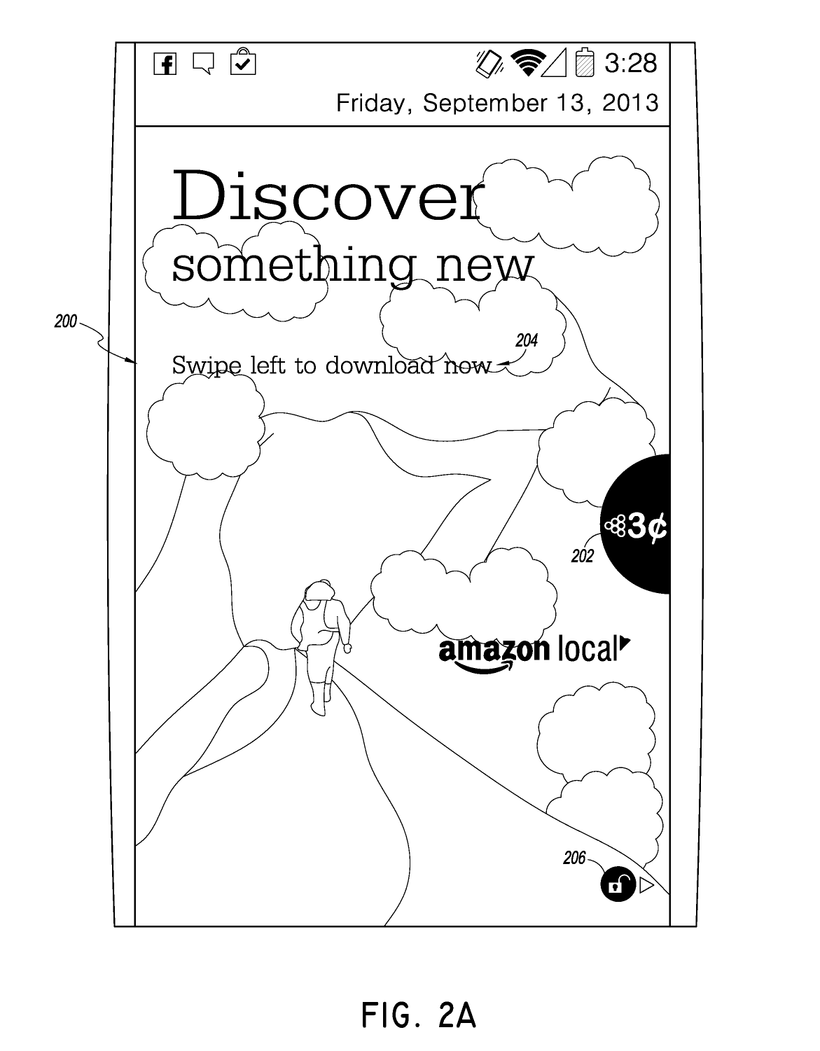

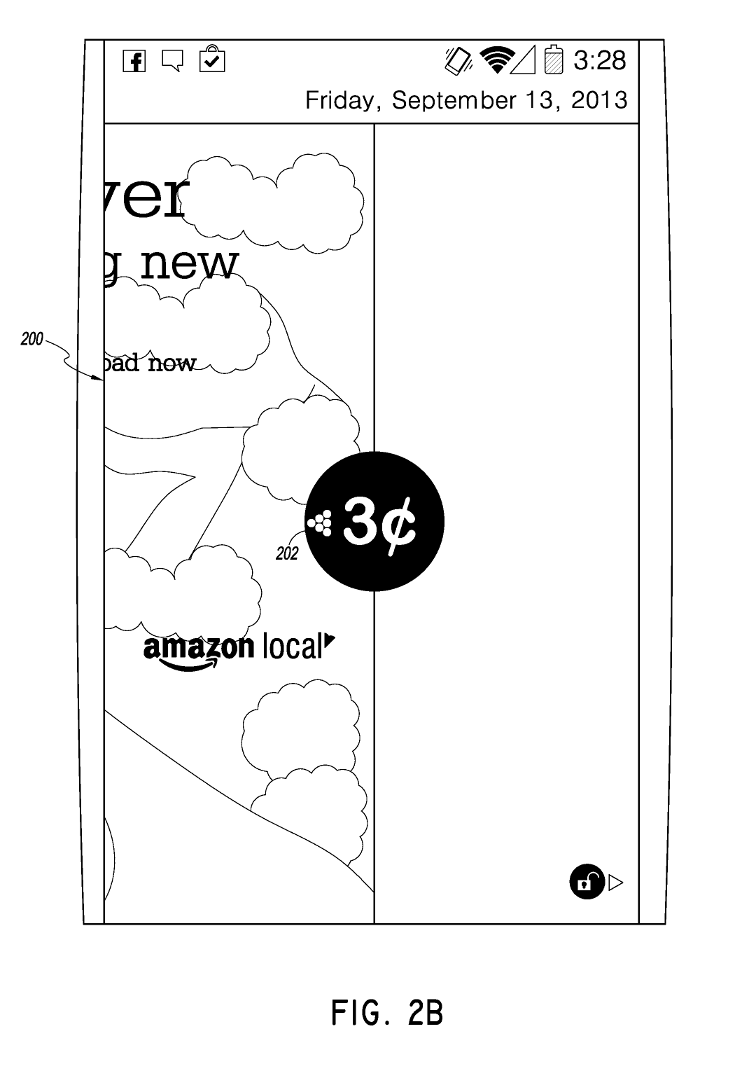

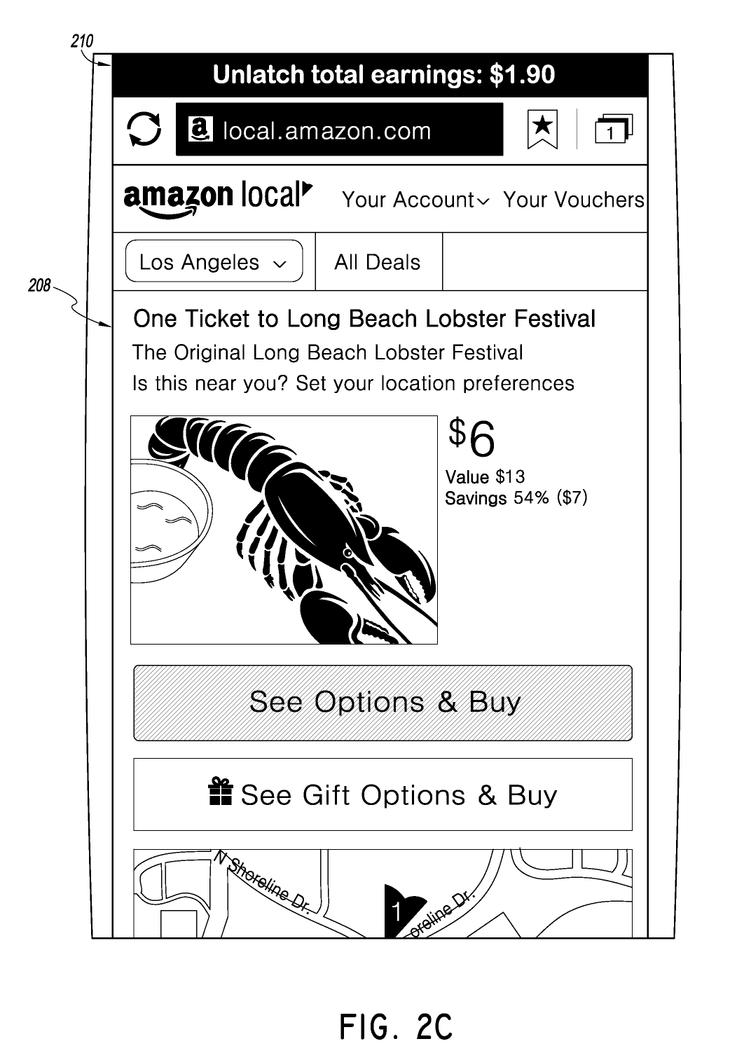

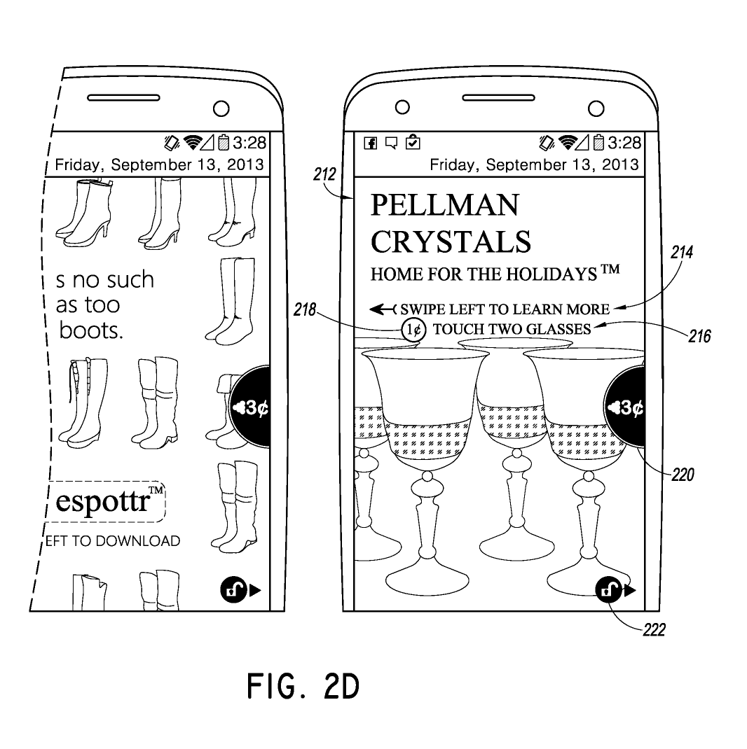

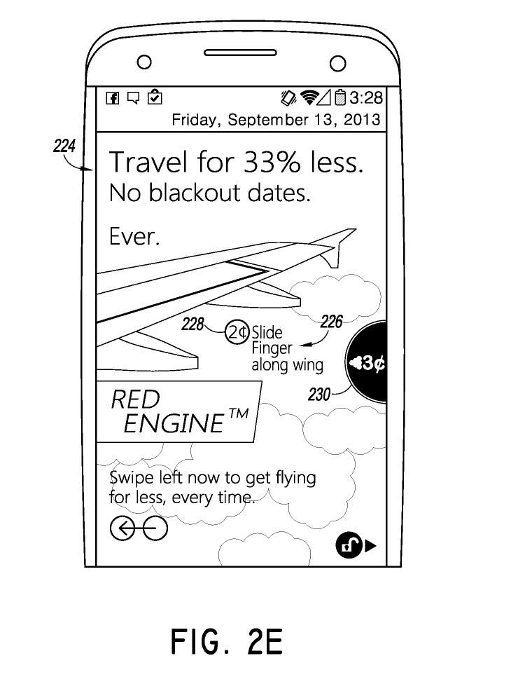

With regard to FIG. 2A, a screenshot of an illustrative lock screen having an illustrative lock screen content 200 displayed thereon is shown. In accordance with one embodiment, the lock screen content 200 may include text, graphics, images, photographs, video, music, or any other static or dynamic graphic, as understood in the art. The content 200 may be informational, promotional, entertainment, or otherwise. In addition to including a graphic, to allow a user to know how much he or she will earn by accessing information associated with the lock screen content 200, a graphical indicia or representation 202, such as an amount of currency or other compensation, that indicates to the user how much compensation he or she will earn. As shown, a “$0.03” amount is presented in a half-circle, which indicates to the user that in response to selecting the lock screen content to view additional information associated with a lock screen content, that he or she will earn $0.03. In addition to the compensation indicator 202, a message 204, such as “swipe left to download now,” may be displayed on the lock screen content 200 to inform the user that by swiping the screen with his or her finger to the left will cause the information associated with the lock screen content 200 to be displayed. As currently exists, the lock screen indicia 206 indicative of unlocking the lock screen to access a homepage or other active page of the mobile electronic device may be shown on the lock screen content 200.

With regard to FIG. 2B, a screen shot of the lock screen content 200 is shown having been slid to the left in an attempt by the user to access information associated with the lock screen content 200. As shown, the reward or compensation indicia 202 is also shown having been slid to the left, and in association with the lock screen content 200.

With regard to FIG. 2C, a screenshot of information 208 associated with the lock screen content 200 (FIGS. 2A and 2B) is shown. In this case, the information 208 is a webpage on a mobile browser of a mobile electronic device, such as a smart phone. At the top of the screen shot, information 210 indicative of a total earnings amount by the user is shown. In this case, an “unlatched total earnings: $1.90” is shown, which indicates a total amount of earnings that the user has generated in interacting with or accessing information associated with lock screen content.

With regard to FIG. 2D, a screenshot of an illustrative lock screen content 212 is shown. The lock screen content 212 may include content, in this case the name of a product, images of drink glasses, and so on, in addition to instructions 214 for accessing information associated with the lock screen content 212, instructions 216 for interacting with the lock screen content, reward or compensation indicia 218 for interacting with the lock screen content 212, reward or compensation indicia 220 for accessing information associated with the lock screen content 212, and a conventional unlock screen indicia 222 for unlocking the lock screen of the mobile electronic device is shown.

With regard to FIG. 2E, a screenshot of an illustrative lock screen content 224 is shown. In one embodiment, instructions 226 that provide for a user to interact with the lock screen content may be presented to a user. In this case, “slide finger along wing,” is provided in association with a reward or compensation indicia 228 of which a user is compensated in response to performing an interaction as directed by the instructions 226. Additionally, compensation indicia 230, in this case $0.03, is shown that indicates how the user is to be compensated in response to accessing information associated with the lock screen content 224.

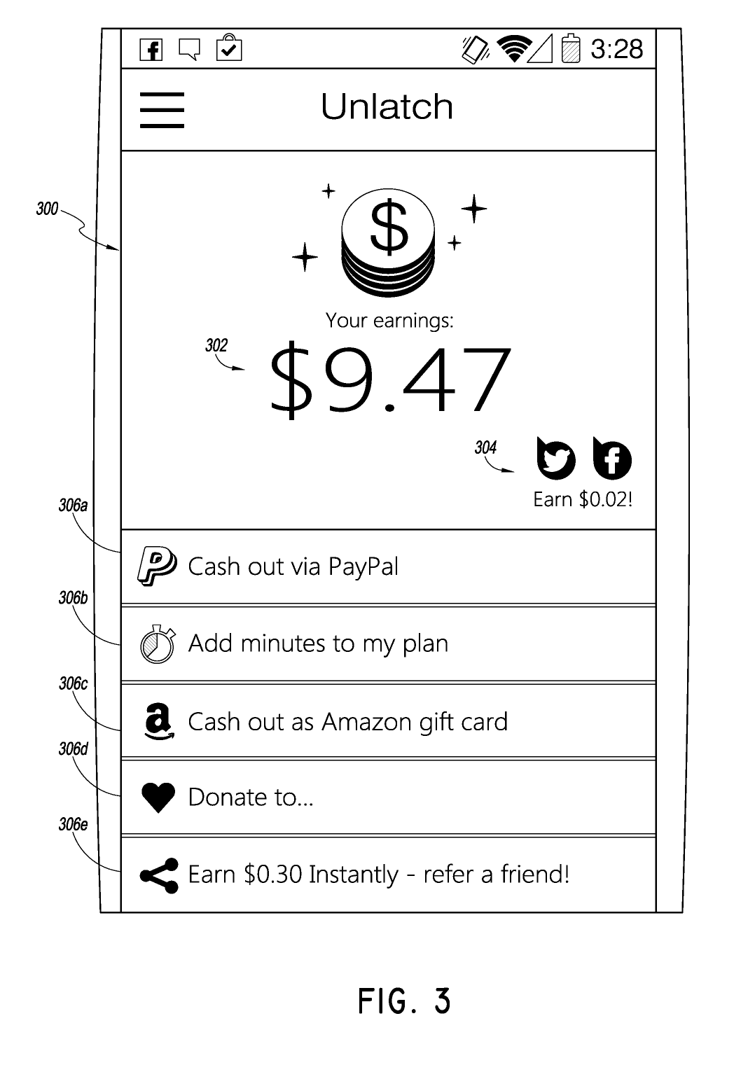

With regard to FIG. 3, a screenshot of an illustrative earnings or rewards management page 300 is shown. The rewards management page 300 may include a total earnings amount 302 that is an aggregate of all the earnings that the user has been awarded responsive to lock screen content. In one embodiment, and indicia 304 showing that the user may earn additional rewards by associating their lock screen account with Twitter, Facebook, or other social networking site is shown. In one embodiment, a reward amount, in this case $0.02, is awarded to users for associating their social networking accounts with the lock screen content distribution account. In addition to showing a total amount of earnings, other time periods, such as daily, weekly, monthly may be provided. Other statistics, such as average, number per day, week, month, year, may be displayed, as well.

In managing their rewards, the user may be provided with a number of different options, including a “cash out via PayPal” option 306a, “add minutes to my plans” option 306b, “cash out as Amazon gift card” option 306c, “donate to . . . ” option 306d, and “earn $0.30 instantly—refer a friend!” option 306e (collectively 306). Other and/or additional options for managing earnings or rewards from lock screen content may be provided, as well.

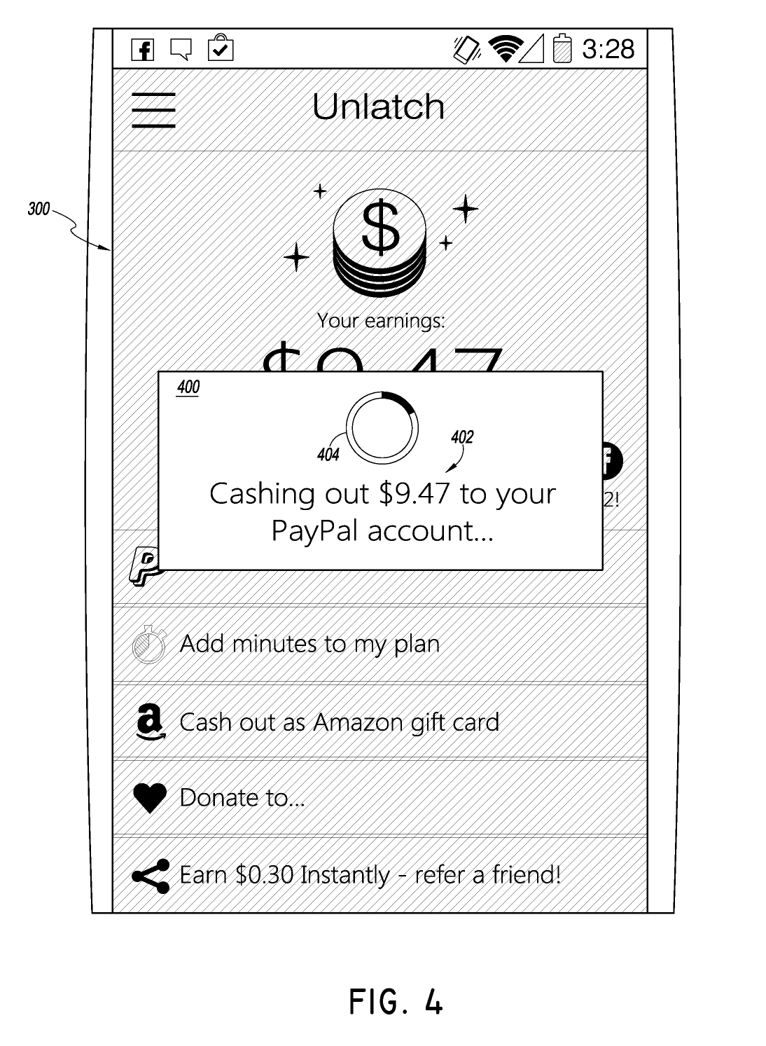

With regard to FIG. 4, a screenshot of the rewards management page 300 is shown to include a pop-up window 400 inclusive of a message to notify the user of a background process that is occurring in response to the user selecting one of the options 306 (FIG. 3). In this case, an indicia 404 (e.g., rotating circle) may be dynamic to show that an accounting function, in this case moving money to the user's PayPal account, is being performed.

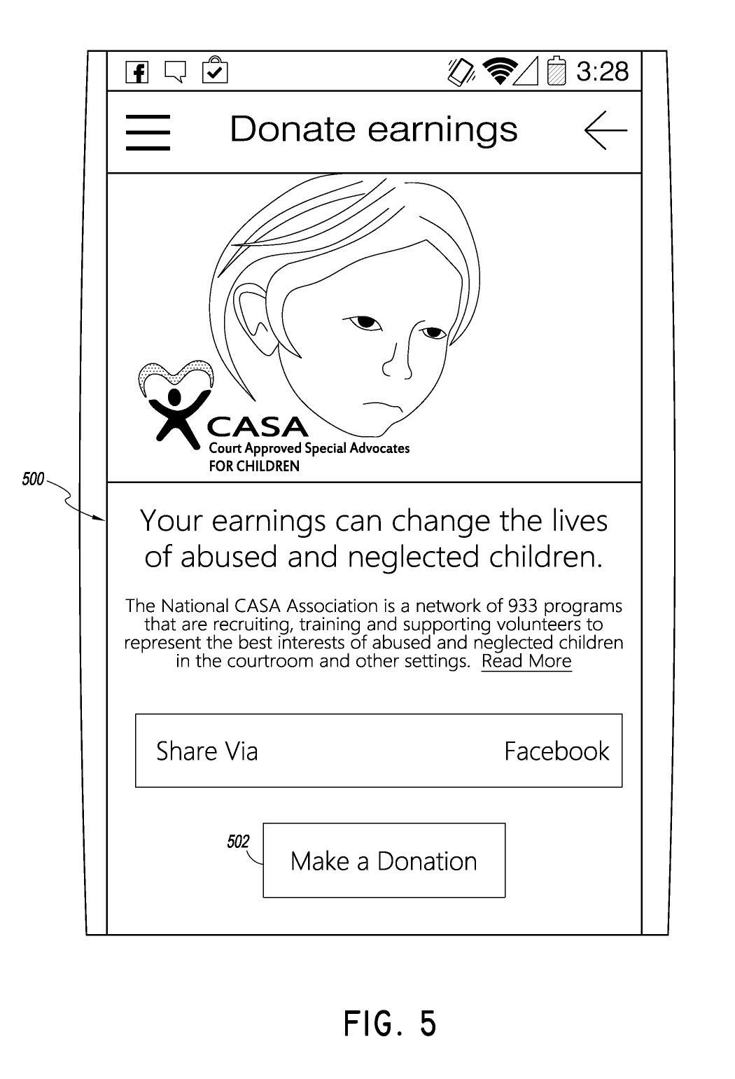

With regard to FIG. 5, a screenshot of an illustrative donations page 500 is shown. In this case, the donations page 500 shows that the user is applying earnings resulting from rewards from interfacing with the lock screen content distribution to a particular charity, in this case CASA. A “make a donation” soft-button 502 enables the user to selectively make a donation to include all or a portion of their earnings of which he or she has accumulated by interacting with lock screen content distribution.

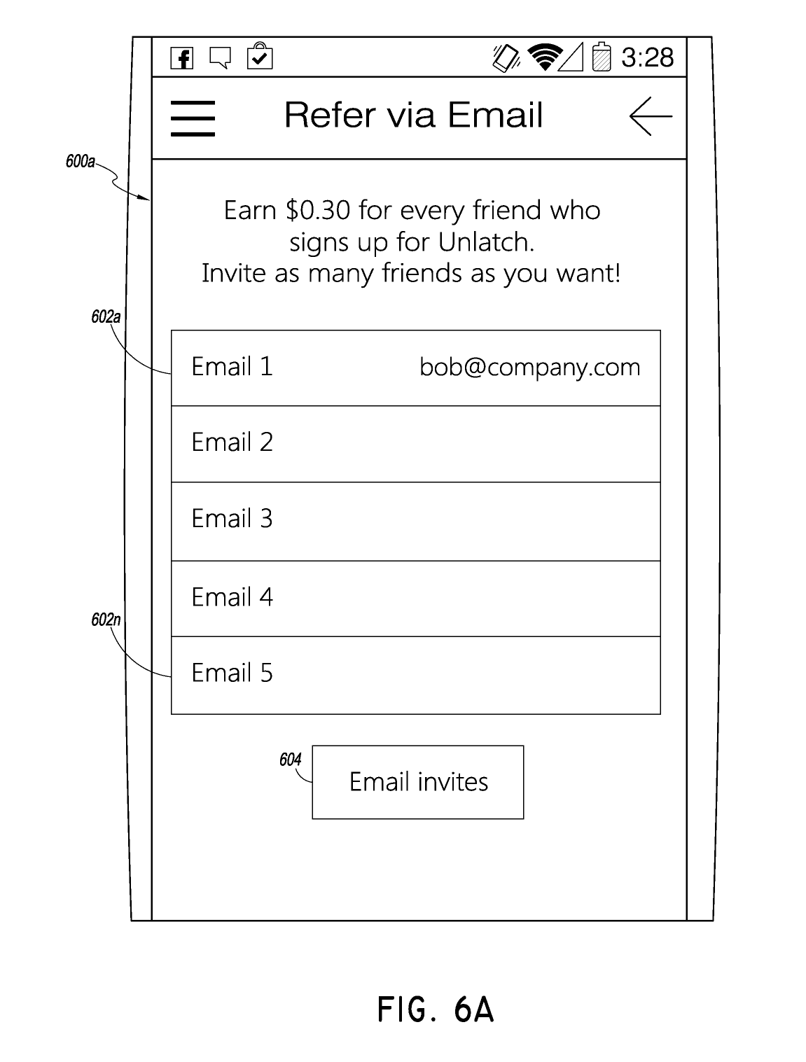

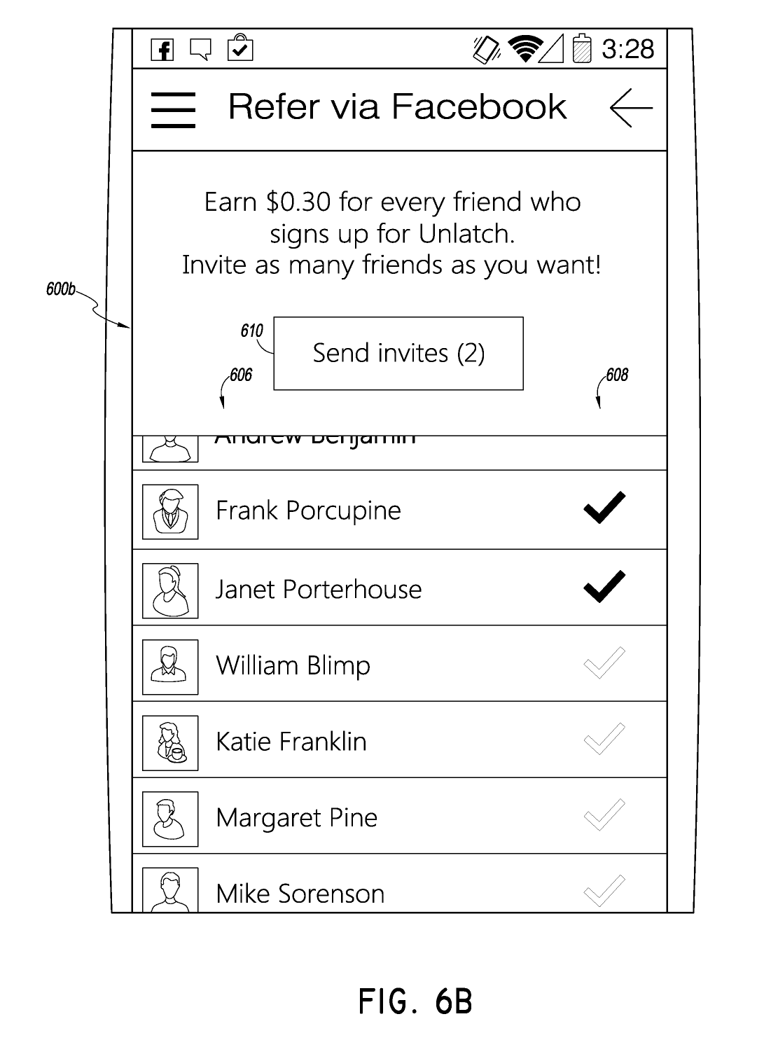

With regard to FIG. 6A, a screenshot of an illustrative referral page 600a is shown. The referral page 600a may enable a user to enter email addresses 602a-602n (collectively 602) of referral friends. In response to the user referring friends to the lock screen content distribution mobile app, the user may earn a reward for each friend that is referred. After the user has entered email addresses, the user may select an “email invites” soft-button 604 to initiate emails to each of the friends of the user.

With regard to FIG. 6B, a screenshot of an illustrative invite page 600b is shown. The invite page 600b enables the user to send invites to the user's Facebook friends 606 by selecting each of the user's friends, as indicated by check-marks 608 next to the names of the Facebook friends. User may select a “send invites” soft-button 610 to initiate invites to be sent to each of the Facebook users with which the user has selected. As with sending emails, the user who invites Facebook friends may earn compensation or a reward for each friend that he or she has invited to use the lock screen content distribution.

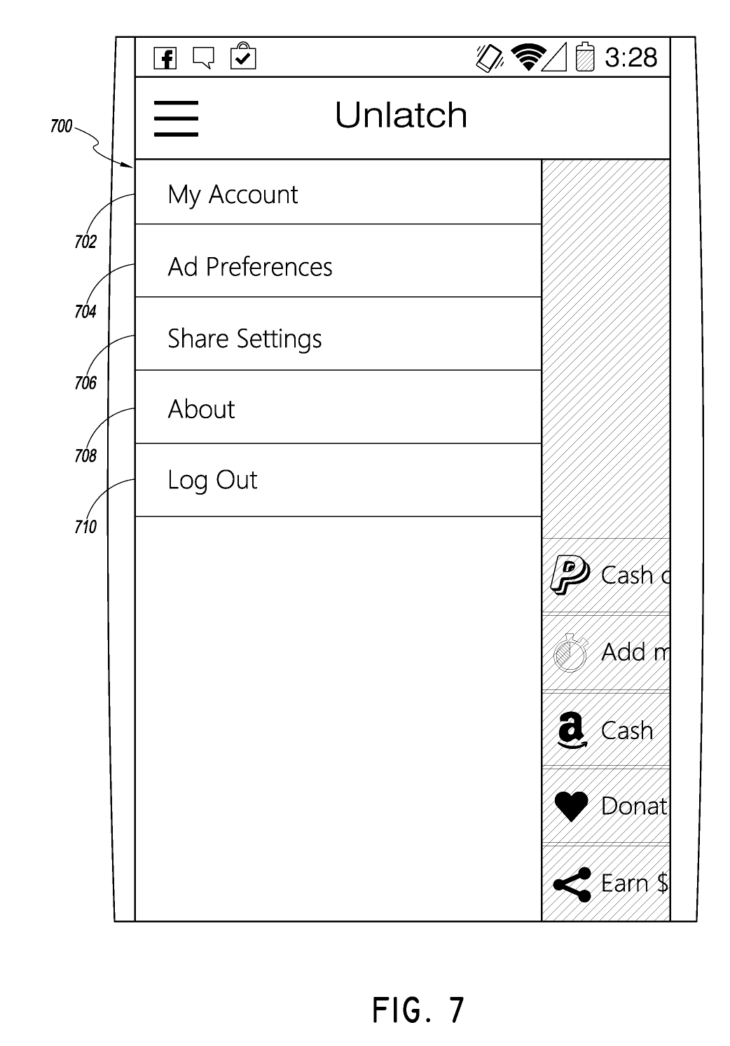

With regard to FIG. 7, a screenshot of an account management home page 700 is shown. Because mobile home page 700 included in number of different options, including a “my account” option 702, a “preferences” option 704, a “share settings” options 706, an “about” option 708, and a “log out” option 710. The options may be selected by the user to access and operate the various functions of the respective options.

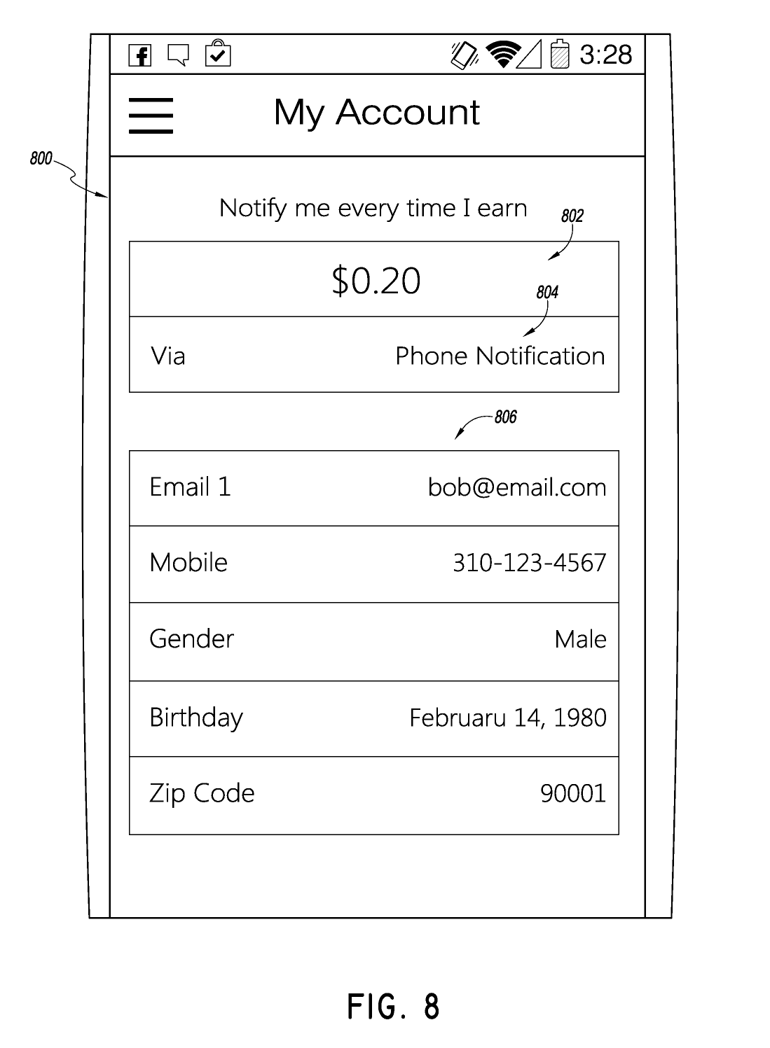

With regard to FIG. 8, a screenshot of an illustrative “my account” option 800 is shown. The “my account” option 800 may include a variety of functions, including a notification option, whereby the user may be notified each time the user earns a certain amount of money. As shown, a text entry field 802 may allow the user to enter or select an amount of money or threshold that triggers the notification to occur. The user may also have a text entry field 804 that enables the user to select or enter an electronic address or device to which a notification of earnings may be sent.

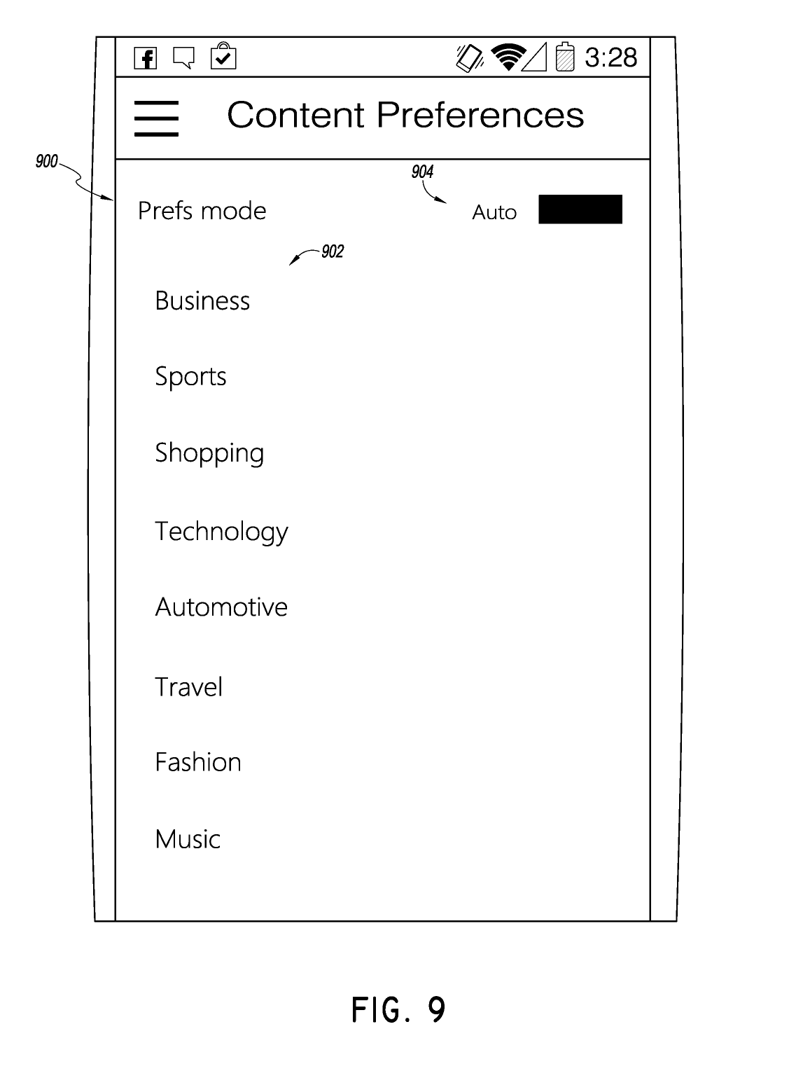

Additionally, the user may be provided with the number of data fields that further assist the lock screen content distribution system to contact the user (e.g., email address, mobile telephone number, etc.) and demographically identify the user, (e.g., gender, birthday, ZIP code, etc.). It should be understood that any additional contact, demographic information, or other information (e.g., marital status, number of children, number of pets, etc.) may be included. Other account information may additionally and/or alternatively be provided in accordance with one embodiment to further assist the lock screen content distribution system to provide relevant content distribution to the user, as provided in FIG. 9.

With regard to FIG. 9, a screenshot of a content preferences page 900 is shown. The content preferences may include a number of different categories 902 of which the user may find of interest for content to be delivered to the lock screen of the mobile device of the user. The categories 902 may include business, sports, shopping (real-world or on-line), technology, automotive, travel, fashion, music, etc. It should be understood that other and/or alternative preferences and categories may be provided, including local, regional, national, international, etc. In one embodiment, rather than the user manually setting preferences and categories, one configuration may provide for an “auto” detection process that monitors for users selecting to interact with and/or view content in one or more categories and automatically setting those categories as content preference categories.

In an aspect, the categories may be organized in a memory of the mobile device or remote server automatically based on environmental context. For example, the categories may be automatically configured in response to a user being geographically at a home of the user, thereby improving efficiency of memory usage, data processing, and network resources as the server may access content more relevant to the user and the mobile device may be served with more relevant content for a user to be presented.

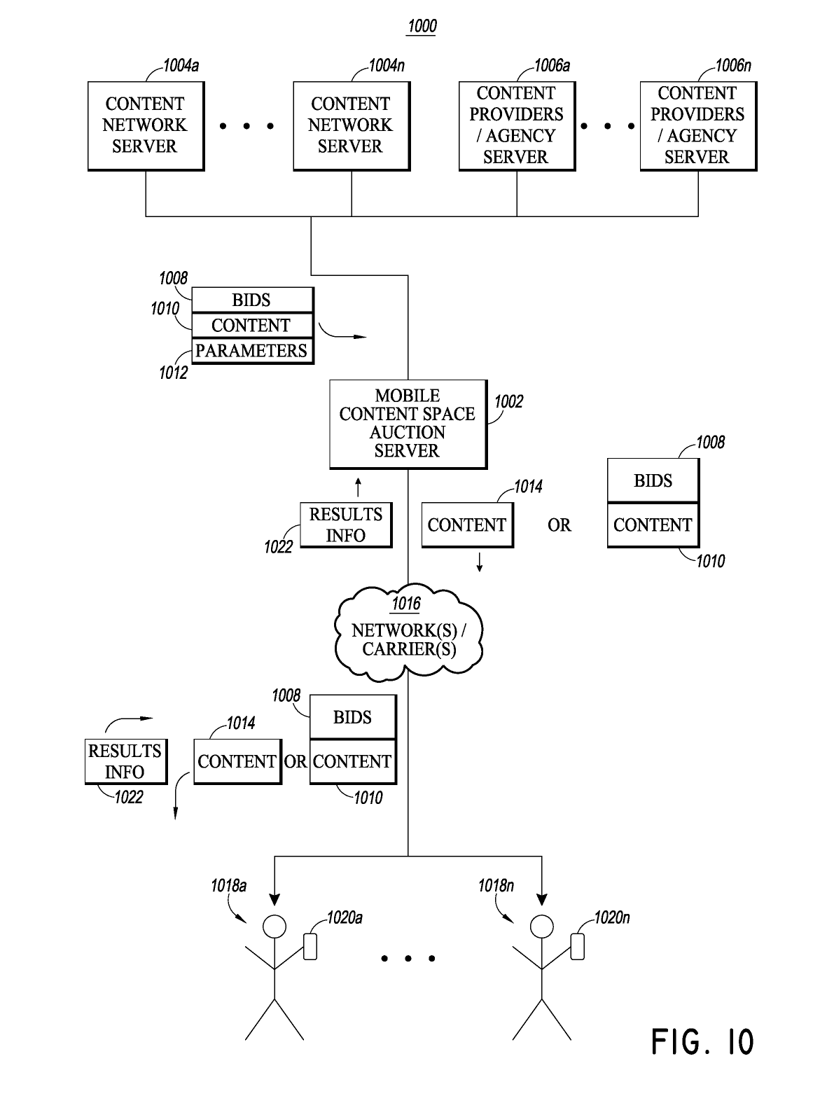

With regard to FIG. 10, and illustration of a network environment 1000 is shown to include a mobile content space auction server 1002 in communication with content servers 1104a-1104n (collectively 1104) and content provider/agency servers 1006a-1006n (collectively 1006). In accordance with one embodiment, the content network servers 1004 may communicate bids 1008, content 1010, and parameters 1012 to the mobile content space auction server 1002 for conducting an auction. In response to the mobile content space auction server 1002 performing an auction using bids 1008 from the content network servers 1004 and/or content provider/agency servers 1006, winning bids may result in the server 1002 communicating content 1014 associated with the winning bid to be communicated via communication network(s) of carrier(s) 1016 to users with mobile electronic devices 1020a-1020n (collectively 1020).

In an alternative configuration, if the mobile content space auction server 1002 is configured to process bids and content and communicate those bids and content 1008 and 1010 to the mobile electronic devices 1020 that are configured to execute auctions, then the mobile content space auction server 1002 may communicate the bids 1008 in 1010 via the networks 1016 to the electronic devices 1020. In either case, the mobile electronic devices 1020 may be configured to generate information associated with lock screen content being displayed thereon and communicate results information 1022 via the networks 1016 to the mobile content space auction server 1002 for storage and processing thereon. In the configuration where the mobile devices 1020 conduct the auctions thereon, the mobile content space auction server 1002 may be configured to use the parameters 1012 for determining where the bids and associate content 1008 and 1010 are to be communicated (i.e., to which mobile devices the bids 1008 and associated content 1010 are to be communicated). By having the mobile devices 1020 conduct the auctions on a local basis, efficiency of processing at the server 1002 may result through distribution of the content and bids. Moreover, if environmental context of the users (e.g., recent activities) is utilized to establish preferences and categories, efficiency may result as relevant content is delivered to the mobile devices 1020.

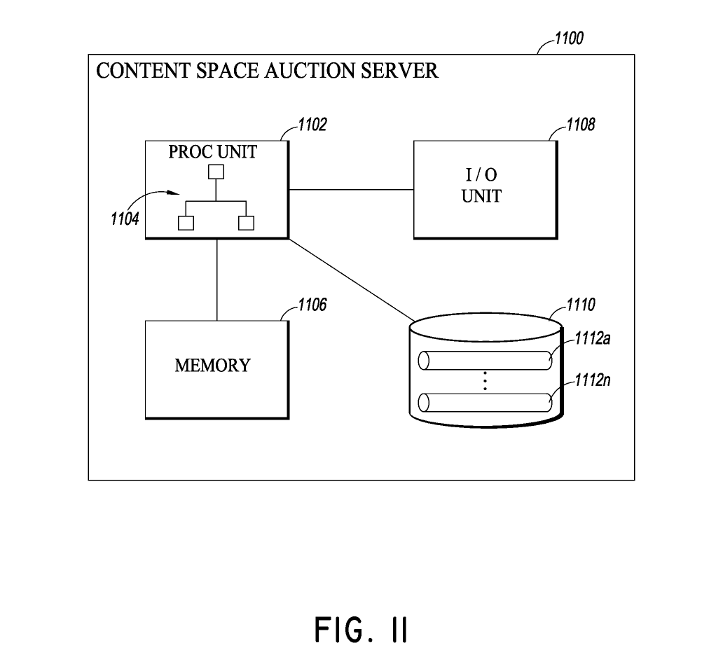

With regard to FIG. 11, a block diagram of an illustrative content space auction server 1100 may include a processing unit 1102 configured to execute software 1104. The processing unit 1102 may be in communication with a memory 1106, input/output (I/O) unit 1108, and storage unit 1110. The storage unit 1110 may be configured to store data repositories 1112a-1112n (collectively 1112). The data repositories 1112 may be configured to store lock screen content, bid submissions, and associated parameters from content providers wanting to display content on lock screens of mobile electronic devices, as further described herein. Additionally, the data repositories 1112 may be configured to store information associated with mobile electronic devices of users, results of lock screen content distribution on the mobile electronic devices, and manage preferences or other user selectable parameters by users in participating in lock screen content distribution.

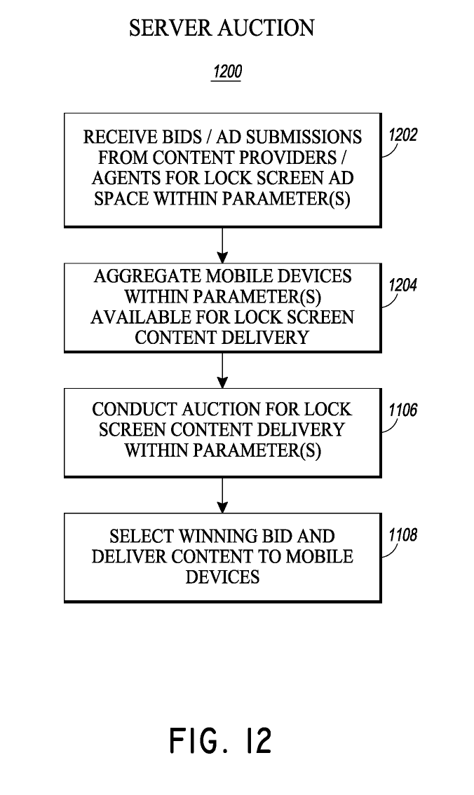

With regard to FIG. 12, a flow diagram of an illustrative auction process 1200 executed on a server, such as server 1100 of FIG. 11, is shown. The process 1200 may start at step 1202, where bids/content submissions received from content providers/agents for a lock screen content space within parameter(s) may be received. The bids may be fixed or variable bids (e.g., a range of bids), maximum bids, or otherwise, as understood in the art, that content providers are willing to spend in an auction setting for their content to be displayed on lock screens on electronic devices (mobile or otherwise). The bids may be established using programmatic buying, as understood in the art. The auction may be a real-time bidding (RTB) or non-real-time bidding auction. The content submissions may include content for display on lock screens of electronic devices. The content may be static and/or dynamic that allow for users of mobile electronic devices to view content when transitioning the electronic devices from a “sleep” mode to an active mode to reengage the mobile electronic device (or any other electronic device having a lock screen) to view a home page or other screen of the mobile electronic device. The parameters may include one or more parameter of geographic regions (e.g., country, region, state, city, zip code, longitude and latitude), demographics of users (e.g., female, 18-25 years old), day of week (e.g., Saturday), time of day (e.g., morning), or any other content distribution parameter of which a content provider of lock screen content wishes to use to identify desired audiences for the lock screen content.

At step 1204, mobile electronic devices within the parameters available for lock screen content distribution may be aggregated. In aggregating the mobile devices, one or more computing systems accessing one or more data repositories may be utilized to identify an audience as desired by the parameters. At step 1106, an auction for lock screen content distribution within the parameters may be conducted. Again, in conducting the auction, the auction may be performed on a real-time or non-real-time basis. At step 1108, a winning bid (e.g., highest bid, highest bid connected to a first right of refusal or other preferential condition, or otherwise) may be selected and an associated content may be delivered to mobile devices that are within the parameters as submitted by the content provider or its agency. In one embodiment, the winning content may be communicated to the mobile device prior to the user causing the lock screen to be displayed. Alternatively, the winning content may be selected and communicated to the mobile device in response to the user causing the lock screen to be displayed. By communicating the content prior to the lock screen being caused to be displayed, the content may be displayed by accessing the content in local memory.

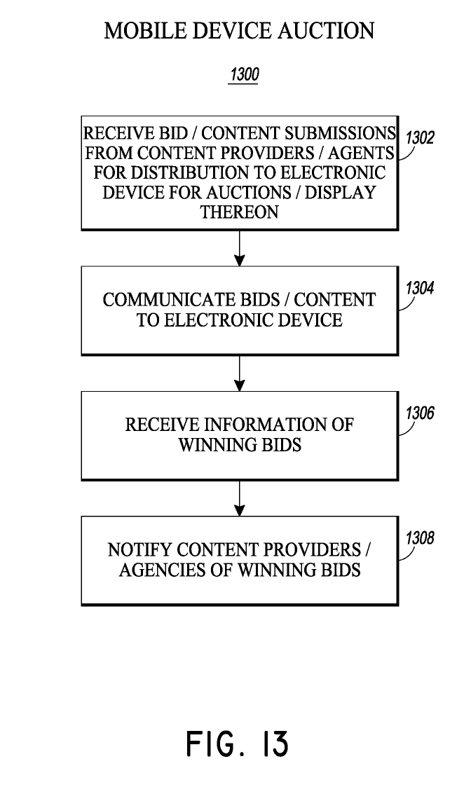

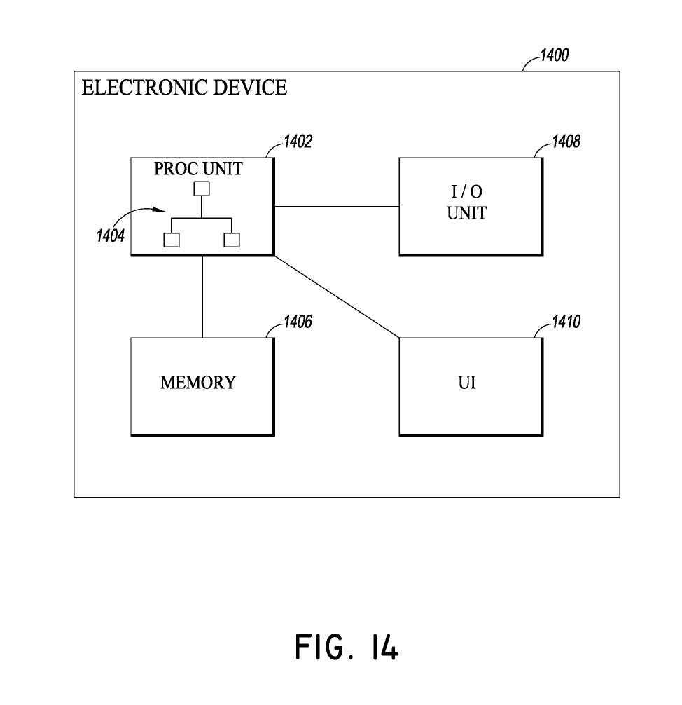

With regard to FIG. 13, a flow diagram of an illustrative auction process 1300 in which content and bids are communicated from a server to a mobile device for conducting an auction on the mobile device is shown. The auction on the mobile device would be a local auction with content and bids executed by a processor of the mobile device, as provided in FIG. 14. The process 1300 starts at step 1302, where bids and content submissions may be received from content providers or their agencies for distribution to an electronic device for auction and display thereon. The reception of the bids and content may be on a server-side computing system, such as a server computer operating on a network. The electronic device is a client-side device, and may be a mobile electronic device, such as a smartphone or tablet. At step 1304, the bids and content may be communicated to the electronic device. In communicating the bids and content to the electronic device, a server may generate content packages each inclusive of content and a bid. Additional information may be communicated with content packages, such as parameters that indicate when content is to participate in an auction, such as day of week, time of day, context environment (e.g., work-related activity, leisure-related activity, and so forth). In one embodiment, the auction on the electronic device may be performed for a lock screen content to be displayed on a lock screen, and be performed in response to a user causing the electronic display to enter a lock screen mode. The auction may be executed by an application or app on the electronic device.

At step 1306, information of winning bids may be received from the electronic device. The information may include number of times content won, amounts of the winning bids, time of display of the winning content, and so on. To protect the actual amount from competitors of the winning content providers, the amounts may be encrypted or otherwise protected (e.g., communicating a non-scaled value that is scaled at the server). At step 1308, content providers and/or their agencies may be notified of the winning bids so that the content providers may compensate a content distribution delivery network. In one embodiment, the mobile device may collect information of winning content, statistics of content displayed (e.g., number of times content is displayed, duration of time content is displayed, number of times content is selected, and so on), and the information may be communicated to the server for processing on a periodic or aperiodic basis in an aggregated and/or compressed manner to reduce processing by the server as the server may update a database record all at once rather than multiple times.

With regard to FIG. 14, a block diagram of an illustrative electronic device 1400 is shown. The electronic device 1400 may be any electronic device, such as a computer (desktop or portable), mobile telephone, such as a smart telephone, tablet device, gaming device, or any other electronic device, and be configured to communicate over a communications network (not shown). The electronic device 1400 may include a processing unit 1402 and software 1404 configured to be executed by the processing unit 1402. The processing unit 1402 may be in communication with a memory 1406, input/output (I/O) unit 1408, and user interface (UI) 1410. The I/O unit 1408 may be configured to communicate over a wired and/or wireless communications network, such as the Internet, mobile telephone network, or any other communications network (e.g., wide area network or WAN) using any communications protocol, as understanding the art. The user interface 1410 may include a touchscreen, screen with hard-buttons, such as a keyboard, audio interface, or any other user interface, as understood in the art.

The software 1404 being executed by the processing unit 1402 may be configured to operate a lock screen that prevents undesired interactions with the electronic device 1400. The software may include an application or mobile app that operates a lock screen that is capable of displaying content as part of or on top of the lock screen. In one embodiment, the software 1404 may be configured to execute an auction on the electronic device, as further provided herein.

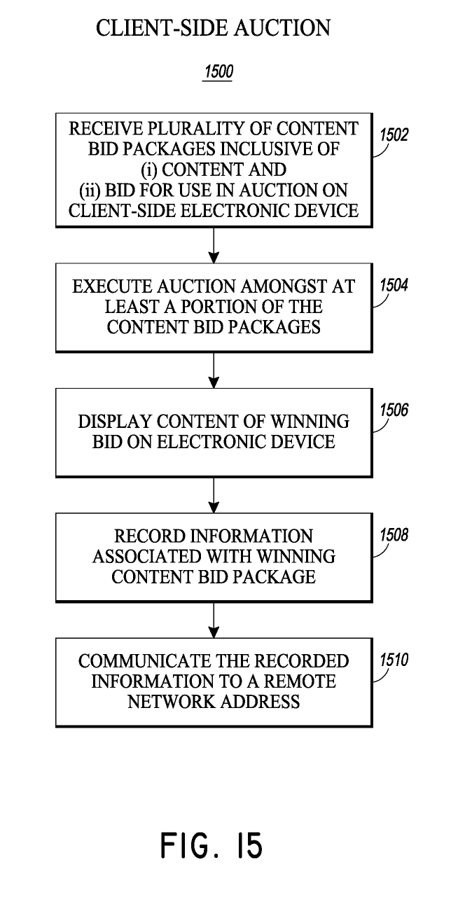

With regard to FIG. 15, a flow diagram of an illustrative client-side auction process 1500 that may be executed on an electronic device is shown. The process 1500 may start at step 1502, where multiple content bid packages are received. The content bid packages may include (i) content and (ii) bid for use in an auction on a client-side electronic device. In an alternative embodiment, the content bid packages may include additional information, such as parameters associated with content distribution options (e.g., geographics, demographics, maximum spend limit, audience size delivery, etc.) of which a content provider may select for distribution of the content.

At step 1504, an auction amongst at least a portion of the content bid packages may be executed on the client-side electronic device. The auction may include content bid packages that are associated with an environment context of the user at that particular time, related to preferences of a user, associated with a particular geographic location of a user, and so on, as opposed to all content bid packages currently located on the electronic device. That is, the auction may be performed with content bid packages having relevant and related parameters. At step 1506, content of a winning bid may be displayed on the electronic device. In displaying the content, the content may be displayed on a lock screen of a mobile device. Alternatively, the content may be displayed on other content space (e.g., content on a website displayed by a mobile browser). At step 1508, information associated with the winning content bid package may be recorded. In recording the information, the information may include identifier of the content bid package (e.g., name of content provider, identifier associated with and content, etc.), amount of money of the winning bid, date and/or time of the winning bid and display of the content, minimum amount of time for the winning content to be displayed to be counted as a full impression, and so forth. At step 1510, the recorded information may be communicated to a remote network address for storage and use thereat. In one embodiment, the use of the recorded information may include billing a content provider for winning the auction performed on the client-side electronic device.

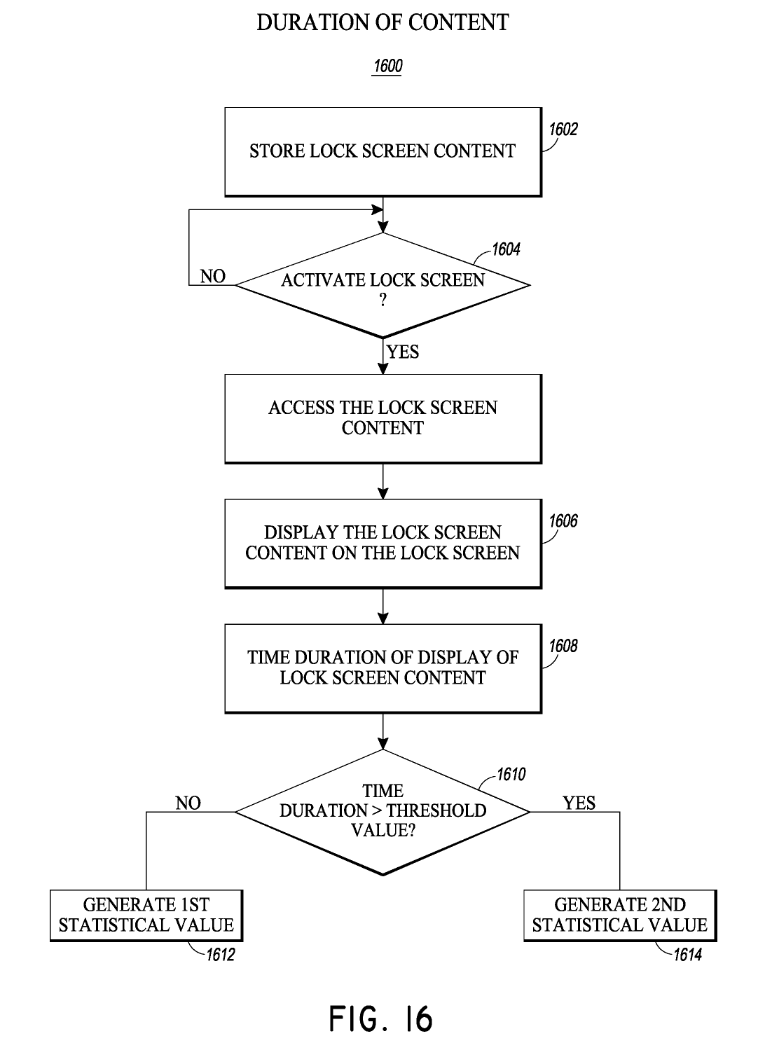

With regard to FIG. 16, a flow diagram of an illustrative process 1600 for monitoring duration of display of content is shown. At step 1602, a lock screen content may be stored. The lock screen content may include digital content representative of lock screen content, as understood in the art. The digital content may include images, text, graphics, photographs, video, music, and so forth, and in any format, as understood in the art. At step 1604, a determination as to whether or not to activate a lock screen is performed. In determining whether or not to activate the lock screen, the determination may be event triggered, which, in the case of a smart phone, may result from a user interacting with his or her electronic device to cause a lock screen to be activated from a sleep mode of the electronic device. If not, then the process repeats at step 1604. Alternatively, if the lock screen is activated, then the lock screen content is accessed from a storage location (e.g., memory of the electronic device). At step 1606, the lock screen content may be displayed on the lock screen. In displaying the lock screen content on the lock screen, the lock screen content may be displayed on a front layer or top layer of the electronic device, as opposed to a deeper layer that resides behind a conventional lock screen, as understood in the art.

At step 1608, a time duration of a display of lock screen content may be measured. The time duration may be measured using a timer, either hardware or software being executed on a processor of the electronic device, from the time that the lock screen content is displayed until a user causes lock screen content to be dismissed as a result of the user accessing a home page, causes another view other than the lock screen of the electronic device, or selects the content to view additional content in response to the user requesting to access information associated with the lock screen content that may be located on a different network address (e.g., different URL) on a communications network, such as the Internet.

At step 1610, a determination may be made as to whether the time duration that was measured for displaying the content is greater than a time duration threshold value. The threshold value may be fixed or set by a content provider for a particular content campaign, for example. If not, then the process continues at step 1612, where a first statistical value is generated. The first acoustical value may be a counter indicative of the content not having been displayed for a minimum amount of time. Additionally and/or alternatively, the statistical value may include an amount of time that the lock screen content was displayed. If at step 1610 a determination is made that the time duration of the lock screen content is greater than a time duration threshold value, then the process 1600 continues at step 1614, where a second statistical value is generated. This second statistical value may include a counter that indicates that content has been displayed for longer than the time threshold value. In one embodiment, the second statistical value may include an amount of time that the lock screen content has been displayed.

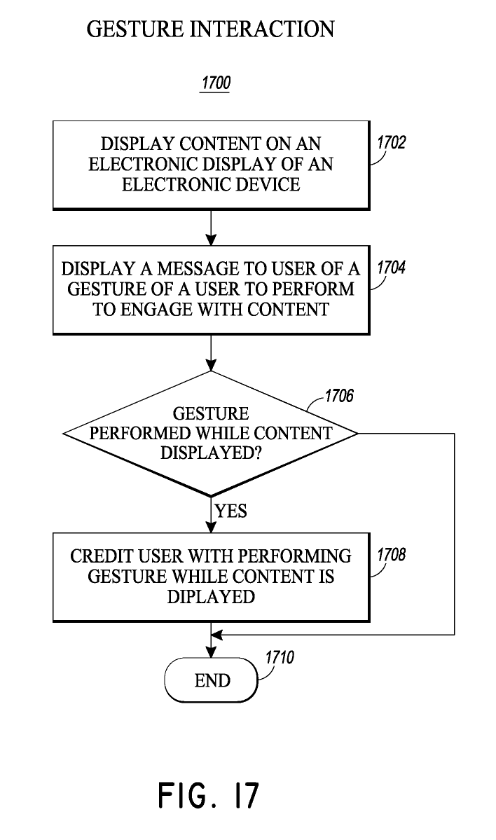

With regard to FIG. 17, a flow diagram of an illustrative gesture detection process 1700 while displaying content is shown. The process 1700 may start at step 1702, where content on an electronic display of an electronic device may be displayed. The electronic device may be a mobile device, such as a smart telephone, tablet, or otherwise, and the electronic device may include particular hardware, such as accelerometers, gyroscope, touch screen, microphone, camera, etc., to sense gestures by a user interacting with lock screen content. A processor may be configured to process data sensed during display of lock screen content to determine the responsiveness and/or gesturing by the user. At step 1704, a message to a user of a gesture of a user to perform to engage with content may be displayed. The gesture may be particular and be creatively related to content (e.g., salt/pepper content with shaking motion of a mobile device). The message may be words, images, static or dynamic indicia, or otherwise that indicate to a user that the user is to perform a gesture that is interactive with the electronic device to indicate that the user has “registered” the content. In “registering” the content, the user merely needs to recognize or view the content for a certain duration of time. The duration of time may be minimal (e.g., 0.25 seconds) in the view of the content provider, but be long enough so that the user receives a branding message as defined by the content provider.

At step 1706, a determination as to whether the gesture has been performed while the content is displayed may be made. The gesture may take a number of different forms, including interaction with a touchscreen (e.g., touch certain spots on content, particular swipe of a finger on the touchscreen), particular movement of the electronic device (e.g., “yoyo” action movement of the mobile electronic device), audible communication to the electronic device by the user (e.g., speak a word or sing a song), facial gesture (e.g., smile to a camera of an electronic device), hand gesture (e.g., show a certain number of fingers), combination thereof, or otherwise. As previously described, in determining whether the gesture has been performed, the electronic device may sense using any of a touchscreen sensor, microphone, mobile electronic device movement sensor, camera, image sensor, or otherwise, and process the sensed gesture data.

In response to determining that a gesture has been performed while the content is being displayed, the process 1700 performs step 1708, where a user is credited with performing the gesture while the content is being displayed. In crediting the user, the user may receive a financial reward or other compensation. In one embodiment, the amount of reward may be determined based on rules established by the content provider (e.g., user who has not previously engaged with content, user who matches multiple demographic or other target audience categories, geographic location of a user when content is displayed for the user, environmental context that matches a desired environmental context for delivering content, etc.). Alternatively, if the user does not perform a gesture while the content is being displayed, then the user is not credited with performing the gesture. In not performing the gesture, the user may simply perform a different function with the electronic device or not interact with the electronic device at all. In one embodiment, the requested gesture may have a time threshold by which the user is to perform the requested gesture, and the determination of step 1708 may have a further requirement that the gesture be performed in a certain time limit. The processor or other timing device may be utilized in measuring and managing the time limit. Alternatively, a minimum amount of time that content has been being displayed may be required for the gesture, which simply means that the user will have time to “register” a message being offered in the content. The process ends at step 1710.

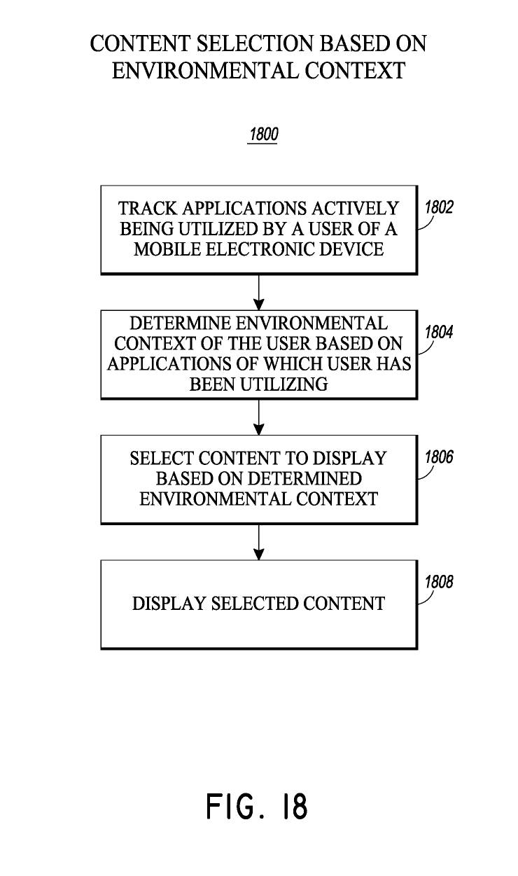

With regard to FIG. 18, a flow diagram of an illustrative process 1800 that may be executed by a processor of an electronic device for selecting content based on environmental context is shown. The process 1800 starts a step 1802, where applications that are actively being utilized by a user of a mobile electronic device are tracked. In tracking the applications that are being utilized, a time of use of the applications may be recorded along with a genre or other indicator associated with an application that may be indicative of an environmental context in which a user of the electronic device is located or operating (e.g., work-related activity, leisure-related activity, which may include shopping-related activities (e.g., being at a retail store or mall, using a shopping application or website on an electronic device, or otherwise), playing a video game, attending a sporting event, etc.). At step 1804, an environmental context of the user based at least in part on the applications of which the user has been utilizing may be determined. In determining the environmental context, the mobile electronic device may access memory in which a recent history of application usage may be stored so that genre or other information indicative of an environmental context of the user may be determined. In one embodiment, a time threshold under which activities of the user are relevant to selecting the content may be set. In some cases, the user may not have been actively using any apps, and the determination may either extend a time limit or use another factor, such as time of day, geographic location, and so on. Still yet, environmental context may be set, reset, and/or changed based on the user changing use of applications, movement, weather, or otherwise, as determined by a local processor of an electronic device or by a server. For example, geographic coordinates of a specific location and environment of that location (e.g., shopping mall, grocery store, home, work, etc.), and motion of the electronic device at a rate at which a vehicle moves may cause the processor to determine that the user is changing his or her environmental context and reset or change the environmental context. As another example, the user may change from using a financial analysis tool to using a gaming application, which may cause a processor, either local (e.g., processor of the electronic device) or remote (e.g., content server on a network) to determine that the user has changed from an work-related environmental context to a leisure-environmental context, which may cause a change in the type of content that is selected to be entered in an auction for content space to be displayed to the user. Moreover, the environmental context may be, in part, utilize weather or other third-party information that may impact a user to assist in content to be bid for display on a lock screen of an electronic device.

At step 1806, content to display based on the determined environmental context may be selected. In selecting the content, the content may be related to a current geographic location in which the user is operating the mobile electronic device, location of the user, current desires of the user, and so on. As an example, if the types of mobile applications of the user has been using are related to games (e.g., game apps), then content associated with leisure time, games, or other non-work activities (i.e., environmental context determined to be leisure) may be selected. Alternatively, if the user is using work-type applications (e.g., dictation software), then content associated with work or other non-leisure activity (i.e., environmental context determined to be work) may be selected for display to the user. At step 1808, the selected content may be displayed. In one embodiment, the selected content may be displayed on a lock screen. Alternatively, the content may be displayed for any other content space on a mobile electronic device. In an alternative embodiment, rather than automatically setting environmental context, a manual selection, such as responding to a prompt with multiple environmental context selections, may be performed. It should be understood that the environmental context may alternatively not be based on applications that the user is or has been using, but rather based on geographic location, time of day, weather, or otherwise, and that the environmental context may be determined based on one or more of the factors or parameters described herein. In that regard, the system may improve content storage, processing, and communications efficiency by limiting content that participates in an auction or other selection mechanism based on the environmental context (e.g., leisure-related content being auctioned for content space on an electronic device in which the environmental context is determined to be leisure-related), thereby improving memory usage, processing, and communications efficiency.

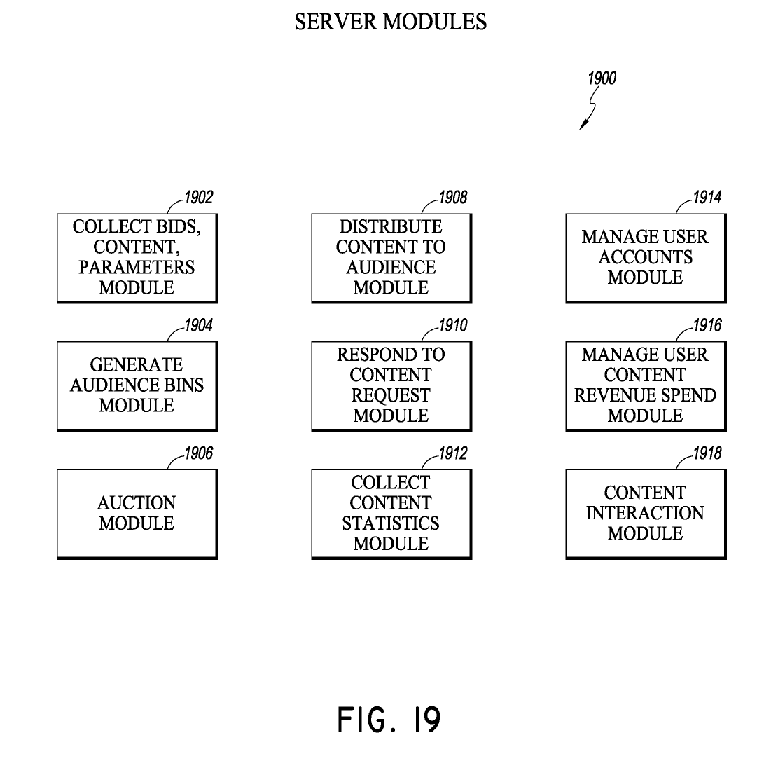

With regard to FIG. 19, a block diagram of illustrative software modules 1900 that may be executed on an electronic device is shown. It should be understood that additional and/or alternative software modules may be utilized in providing for the content distribution platform functionality in accordance with an embodiment. The modules 1900 may be executed by a processing unit of a server operating on a communications network in communication with mobile electronic devices.

A collect bids, content, and parameters module 1902 may be configured to present a graphical user interface to the user and received bids for submission into an auction to display the content may be utilized. The parameters may include parameters of demographics, geographics, date, time, or any other parameter associated with displaying the content. The content may be configured to be displayed on a lock screen of the electronic device.

A generate audience bins module 1904 may be configured to generate bins of electronic addresses of electronic devices associated with users. The bins may be defined by geographic location of the electronic devices, demographics of users associated with the electronic devices, and so forth. By generating the audience bins, content providers may be able to define where and what audience the content provider wishes to reach.

An auction module 1906 may be configured to auction content space (e.g., on a lock screen) from amongst multiple content having respective bids submitted therewith. In one embodiment, the bids that were collected by module 1902 may have specific values, range of values, maximum value, and so on that may be used in the auction by the auction module 1906.

A distribute content to audience module 1908 may be configured to distribute winning content to the audience as elected or selected by the content provider. In one embodiment, rather than just distributing the winning content to the audience (i.e., to electronic devices of the audience), in a configuration where the auction is performed on a client-side device, content packages in the form of content signals may be communicated or distributed to the audience. The content packages may include content and bids associated with the content. In other words, rather than a server performing the auction, a client-side electronic device (e.g., smart phone) may perform the auction.

A respond to request module 1910 may be configured to select content to distribute to a request an electronic device. The module 1910 may be configured to select content that won an auction from the auction module 1906. The module 1910 may be configured to operate in a real-time or non-real-time configuration.

A collect bid statistics module 1912 may be configured to collect statistics of content that is communicated to electronic devices for display thereon. In one embodiment, the module 1912 may collect total number of content distributed, statistics for each individual content, amount of money that is spent for each content that wins an auction by the server or on a client-side electronic device, and so forth. In one embodiment, the module may track an amount of time that each content is displayed on an electronic device. For example, if content is lock screen content, then an amount of time that each content is displayed on the lock screen prior to a user switching from the lock screen to a homepage or other view on the electronic device may be collected and stored. In addition, a number of times that a user accesses information associated with the content may be collected and stored, as well.

A manage user accounts module 1914 may be configured to enable the user to manage his or her account for receiving content. In the case of the user managing an account for receiving lock screen content, a user may have the ability to enter demographic information, geographic information (e.g., home address, work address, vacation home address), contact information (e.g., email address, phone number for text messages, and so forth), subject matters of interest, environmental context options (e.g., leisure time, work time, gaming time, etc.) and so on. Reward collections reporting, such as threshold amounts at which a user is to be notified (e.g., notify after being rewarded every $5), may be established by the user.

A manage user content revenue spend module 1916 may be configured enable a user to manage content distribution revenue that is collected and earned by the user for participating in a content distribution program (e.g., lock screen content distribution program). In one embodiment, how money is to be collected and/or distributed from the account may be established and managed by the user. For example, charities to which the user desires to fund with rewards from viewing or participating in the content distribution program may be managed by the user.

A content interaction module 1918 may be configured to monitor user interaction with content being displayed. In one embodiment, the module 1918 may be configured to monitor user interaction with lock screen content. In monitoring the user interaction, the module 1918 may be configured to sense user interaction with a touchscreen display, sense audio interaction with the mobile device, sense movement of the mobile device, and sense any other interaction with the mobile device as previously described herein. The module 1918 may be configured to track both interactions with content being displayed along with tracking selection of content by a user to access additional information associated with content. That is, interacting with content being displayed through gesturing is different from selecting content to access additional information on a webpage or otherwise, although selecting content is typically initiated via a gesture that is different from an interaction gesture.

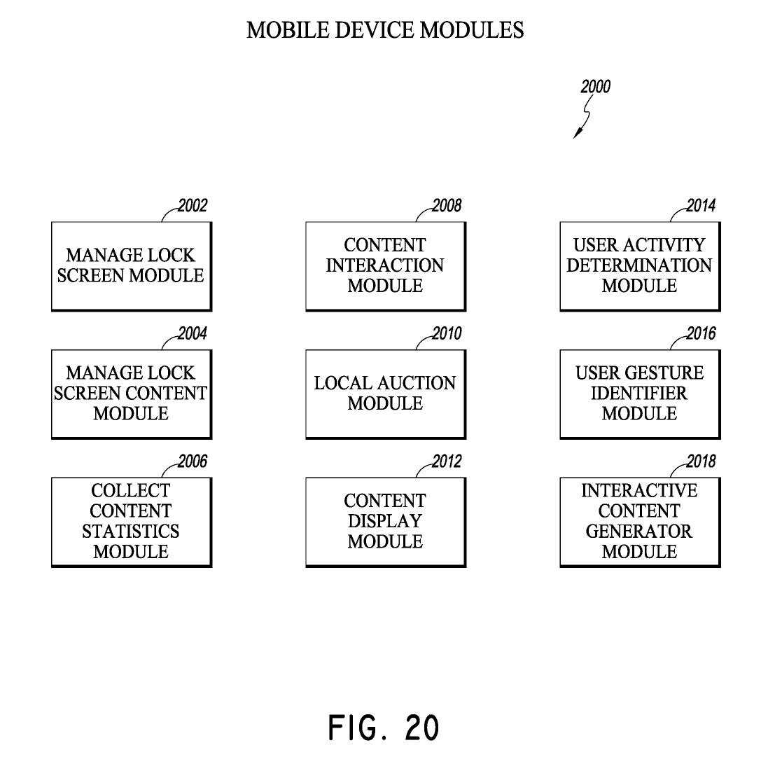

With regard to FIG. 20, a block diagram of illustrative software modules 2000 that may be executed on a mobile device is shown. The software modules 2000 shown are illustrative and may include additional and/or different software modules for performing the functionality in accordance with an embodiment.

A manage lock screen module 2002 may be configured to manage how content is placed onto a lock screen of an electronic device. In one embodiment, the manage lock screen module 2002 may be configured to replace all or a portion of a lock screen with content, and may be configured to manage how and when to display content on the lock screen. For example, the module 2002 may be configured to space out content throughout an hour rather than to display one every time the user views a lock screen. Other management functions for a lock screen of an electronic device may be performed by the module 2002.

A manage lock screen content module 2004 may be configured to receive one or more lock screen content and manage selection order, timing, display, and other operations for content to be displayed on a lock screen. The module 2004 may also be configured to store the content in multiple “buckets” such that genres or environmental contexts (e.g., leisure, at home, shopping) of content are arranged with other content in the same genre, thereby making it easier for the electronic device to select and/or auction content display space on the electronic device.

A collect content statistics module 2006 may be configured to collect statistics that are displayed on the electronic device. In one embodiment, the module 2006 may be configured to collect statistics of how long content is displayed, whether or not the content is displayed long enough for the content distribution to consider the content to have created an impression, whether the user interacted with the content, whether the user selected the content to view additional information associated therewith, and so forth.

A content interaction model 2008 may be configured to determine whether the user interacts with content being displayed. The content interaction module 2008 may also be configured to determine whether the user selects content to view information associated with the content. The content interaction model may utilize one of more physical and/or virtual sensors on an electronic device to determine how and whether the user interacts with the electronic display, which is an indicator as to whether the user is receiving a “message” of content.

A local auction module 2010 may be configured to conduct a local auction for content space on the electronic device using bids submitted by a content provider for the auction. The local auction module 2010 may be configured to perform an auction using all content and associated bids provided to the electronic device or a portion of the content packages communicated to the electronic device. For example, a portion of the packages communicated to the electronic device may be associated with leisure time (examples of which are described elsewhere herein), and if it is determined that the user is performing leisure activities (i.e., environmental context indicative of leisure activities) at the time of a lock screen content request being made, then the module 2008 may auction leisure time content space to content that has been categorized as being leisure time content.

A content display module 2012 may be configured to receive a winning content from the auction conducted by module 2010 or a next content in the queue, if no auction is performed on the client-side electronic device, and display content on an electronic display of the electronic device. The content display module 2012 may also be configured to track which content is displayed, date and time of the content being displayed, location of the content being displayed, timing for the content being displayed, and so on.

A user activity determination module 2014 may be configured to track user activity based on applications (e.g., mobile apps) of which the user actively is interacting or has recently interacted. In one embodiment, a time threshold, such as 1 minutes, 5 minutes, 15 minutes, 30 minutes, or any other timeframe that is indicative of a user's current activity may be established. In one embodiment, the module 2014 may be configured to track geo-positioning and/or movement (e.g., speed, local movement, which is indicative of the device being carried while walking, running, riding in a vehicle, etc.) of the electronic device to determine whether the user is moving from one activity to another so as to determine whether the user might be transitioning from one activity (e.g., work) to another (e.g., home).

A user gesture identifier module 2016 may be configured to determine whether the user performs a requested gesture displayed on content, where a user's performing a gesture on the displayed content is indicative of the user actually “registering” or paying attention to the content. Such a “registration” of the content by the user is beneficial to the content provider and using a physical gesture to track such “registration” may provide enough value to the content provider to pay the user for that interaction. The module 2016 may be configured to identify a number of different physical gestures, including the user touching a touchscreen in certain locations or in a certain manner, making an audible sound, moving an electronic device in a certain manner, and so on.

An interactive content generator module 2018 may be configured to generate interactive content that requests a gesture from the user. That is, if the user is to perform a certain gesture that is to be measured or sensed by the electronic device, then module 2018 may be configured to generate content with multiple layers (e.g., touch layer on top of a display layer, a moving “bulls-eye” on top of content, etc.) for the content display module 2012 to display the interactive content generated by the module 2018.

### Duration of Content Display Tracking

One embodiment of a process of presenting mobile content may include storing, in a memory by a processing unit, lock screen content on a mobile device. Responsive to a user of the mobile device activating the mobile device to cause the processing unit to display a lock screen, the processing unit may access lock screen content from the memory, and display the lock screen content on the lock screen. A duration that the lock screen content is displayed may be timed. In response to the processing unit determining that the lock screen content is displayed for a time duration below a minimum view time threshold value, a first statistical value indicative of the lock screen content not having been viewed may be generated. Otherwise, a second statistical value of the content having been viewed may be generated.

The generation of the first statistical value indicative of the lock screen content not having been viewed may include incrementing a counter associated with the lock screen content representative of number of times that the lock screen content has not been viewed. In one embodiment, credit may be applied to a content provider of the lock screen content based on a value of the counter. The first and second statistical values may be communicated to a computing system operating on a communications network. The minimum view time threshold value may be adjusted based on a parameter set by a content provider of the content, whereby the minimum view time may be utilized to adjust cost value to the content provider.

### Content Space Auction

One embodiment of a method of distributing content to electronic devices may include collecting, by a computing system, (i) content from multiple content providers, (ii) bids associated with the respective content, and (iii) one or more parameters defining a content distribution specification, where the content and respective bids may be included in a content bid package. Multiple content bid packages may be communicated via a communications network to an electronic device to enable the electronic device to execute an auction using the content bid packages and to display content of a winning bid package of the auction on the electronic device. In response to receiving, by the computing system, information indicative of the winning content bid package from the electronic device, a data record associated with a content provider may be updated with the winning content bid package. The information may include data representative of a bid value that won the auction. The content provider associated with the winning content bid package the bid value that won the auction may be billed.

In one aspect, the communications may be to a mobile communications device. Moreover, a determination of a geographic region from the parameter(s) associated with a content bid package in which to communicate the content bid package may be made. A set of content bid packages may be formed to be distributed within the same geographic region of the content bid package, and the content bid packages may be communicated to electronic devices in the geographic region. A determination of a demographic of a user from the parameter(s) associated with a content bid package may be made. A set of content bid packages may be formed to be distributed to users with the same demographic as the content bid package. The set of content bid packages may be communicated to electronic devices with users matching the demographic.

In receiving information indicative of the winning content bid package, a winning bid value may be received, where the winning bid value may be a dollar amount. In collecting bids associated with the respective content, bids that content providers are willing to pay for content to be displayed on a single mobile device may be collected. In receiving the parameter(s), an indication of an activity type of which the content provider wants for the content to be displayed in association may be received. The indicator may be an indicator indicative of shopping. Alternatively, the indicator may be an indicator that is indicative of leisure time.

In one embodiment, updating may include calculating a total amount of money spent in each winning auction of content. Receiving bids may include receiving a range of bids from each content provider that the respective content providers are willing to make for displaying content on an electronic display. Collecting the bids includes collecting the bids for the content of the content to be displayed on a lock screen of a mobile electronic device.

### Auction on Client-Side Device

One embodiment of a method of displaying content space on an electronic device may include receiving, by an electronic device on which content is to be displayed, content bid packages inclusive of (i) content and (ii) a bid for use in an auction. An auction, by the electronic device, may be performed to auction content space amongst at least a portion of the content bid packages using respective bids in bidding on the auction. In response to determining winning bid, content associated with the winning bid may be displayed by the electronic device. The electronic device may store information associated with a content bid package and an amount of the winning bid. The electronic device may communicate the stored information to a remote network address via a communications network.

In one embodiment, a determination of an environmental context of a user based on recent applications operated by the user on the electronic device may be made. At least a portion of the content bid packages may be selected as a function of the determined environmental context in which to participate in the auctioning. The selection may include selecting content packages related to leisure time. Alternatively, the selection may include selecting content packages related to shopping. Still yet, selection of content packages may be related to work. Optionally, the selected content is not displayed using the applications utilized to determine the environmental context of the user. For example, if the electronic device determines that the user's environmental context is leisure (e.g., based on the user's use of a music playback application), the selected content is optionally not displayed via the music playback device, but may instead be displayed via another application or user interface (e.g., via a lock screen). That is, environmental context may be determined based on current and/or recent applications or activities that have been utilized on the electronic device, and the environmental context may be used to enable content providers to better target audiences via the electronic device, but not necessarily within an application that was used in determining the environmental context. For example, the audience may be captured via a lock screen. The electronic device may be a mobile electronic device. Auctioning the content space may include auctioning lock screen content space.

### Gestures

One embodiment of a method of engaging a user with content displayed on an electronic device may include displaying content on an electronic display of the electronic device. A message may be displayed on the electronic display to a user of a gesture for the user to perform that, if performed, is indicative of the user engaging with the content. A detection may be made by the electronic display as to whether the user performs the gesture while the content is being displayed. In response to determining by the electronic display that the gesture has been performed by the user while the content is being performed, the user may be credited with performing the gesture while the content is being displayed.

In determining that the gesture has been displayed, a determination that the user has performed a gesture on the electronic display may be made. In one embodiment, a reward value to be credited to the user may be displayed in association with the content in response to the user performing the gesture. The crediting may include crediting the reward value to the user. A request may be received from the user selecting the content to view information associated with the content on another display page. In response to receiving the request, the user may be credited for selecting the content to view the information. A reward value to be credited to the user in association with the content in response to the user selecting to view the information may be displayed. The request may be generated in response to the user performing a gesture to select the content. The content may be displayed on a lock screen of the electronic device.

In one aspect, one or more applications of which the user has been using during a predetermined time duration prior to displaying the content may be tracked. In response to preparing for the content to be displayed, content to be displayed based on type of the one or more applications may be selected. Selection of the content may include selecting content by an auction executed by the electronic device.

The systems and methods use a specially-programmed computer system that has the capability to perform the complex computations and automated functionality that cannot be reasonably performed by a person. The computations and functionality are envisioned to be performed by a non-human system, including hardware, software, and/or firmware. The computations and functionality require cannot be performed by a generic computer, but rather a specially-programmed computer that is configured to perform the complex computations and functionality described herein. The techniques and processes described herein may also improve the efficiency of the specially-programmed computer by performing discrete tasks that can more optimally process data.

The previous description is of a preferred embodiment for implementing the invention, and the scope of the invention should not necessarily be limited by this description. The scope of the present invention is instead defined by the following claims.

What is claimed is:

1. A method of selecting content to display on an electronic device, said method comprising:
tracking, by the electronic device, applications that are actively being utilized by a user of the electronic device;
determining, by the electronic device, an environmental context of the user based at least in part on the applications of which the user has been utilizing;
selecting content to display based at least in part on the determined environmental context of the user; and
causing the selected content to be displayed, the selected content not being displayed by the applications utilized to determine the environmental context of the user.

2. The method according to claim 1, wherein determining the environmental context further includes (i) accessing weather information at a geographic location at which the electronic device is located and (ii) generating an environmental parameter representative of the weather information.

3. The method according to claim 1, wherein determining the environmental context further includes determining geographic location of the electronic device.

4. The method according to claim 3, wherein determining the environmental context includes determining whether the user is engaged in a work-related or leisure-related activity.

5. The method according to claim 1, wherein causing the selected content to be displayed includes displaying the selected content on a lock screen of the electronic device.

6. The method according to claim 1, further comprising determining demographic information of the user, and wherein selecting content includes selecting content based at least in part on the demographic information of the user.

7. The method according to claim 1, further comprising determining whether the displayed content has been displayed longer than a minimum time duration threshold value.

8. The method according to claim 1, wherein selecting content further includes matching at least one parameter established by a content provider with a parameter indicative of the environmental context.

9. The method according to claim 1, wherein selecting content includes conducting a real-time bidding auction of multiple content, and wherein the winning bid content is the selected content.

10. A system comprising:
a computing device;
non-transitory memory in communication with said computing device, and that stores instructions that, when executed by the computing device, cause said computing device to:
track applications utilized by a user of the system;
determine an environmental context of the user based at least in part on the applications of which the user has been utilizing, the environmental context being indicative of an activity-type in which the user is engaged;
select content to display based at least in part on the determined environmental context of the user; and
cause the selected content to be displayed on a lock screen.

11. The system according to claim 10, wherein the environmental context indicates whether the user is engaged in a work-related activity or a leisure-related activity.

12. The system according to claim 10, wherein the selected content is not caused to be displayed using any of the applications utilized to determine the environmental context of the user.

13. The system according to claim 10, wherein the instructions, when executed by said computing device, further cause said computing device to determine geographic location of the user.

14. The system according to claim 10, wherein the instructions, when executed by said computing device, further cause said computing device to determine weather conditions at the user.

15. The system according to claim 10, wherein the system is remotely located via a communications network from an electronic device configured to display the lock screen.

16. A method of selecting a content to display on an electronic device, said method comprising:
tracking, by the electronic device, one or more applications utilized by a user of the electronic device;
determining, by the electronic device, an environmental context of the user based at least in part on the one or more applications of which the user has been utilizing, the environmental context indicating an activity-type in which the user is engaged;
selecting content to display based at least in part on the determined environmental context of the user; and
causing the selected content to be displayed, the selected content not being displayed by the one or more applications utilized to determine the environmental context of the user.

17. The method according to claim 16, wherein the environmental context indicates whether the user is engaged in a work-related activity or a leisure-related activity.

18. The method according to claim 17, wherein the leisure-related activity is a shopping-related activity.

19. The method according to claim 16, wherein the selected content is not displayed using the applications utilized to determine the environmental context of the user.

20. The method according to claim 16, wherein determining the environmental context further includes determining geographic location of the electronic device.

21. The method according to claim 16, wherein determining the environmental context further includes determining weather at the electronic device.

22. The method according to claim 16, further comprising:
determining that the environmental context of the user has changed; and
changing the environmental context.

23. The method according to claim 16, wherein causing the selected content to be displayed includes causing the selected content to be displayed on a lock screen of the electronic device.

24. The method according to claim 16, wherein selecting content includes conducting a real-time bidding auction of multiple content, and wherein the highest bid content is the selected content.
